(19) United States
(12) Patent Application Publication
(10) Pub. No.: US 2018/0320965 A1
(43) Pub. Date: Nov. 8, 2018

(54) DRYER AND CONTROLLING METHOD THEREOF

(71) Applicant: LG Chem, Ltd., Seoul (KR)

(72) Inventors: Hyung Sop Kim, Daejon (KR); Won Chan Park, Daejon (KR); Yong Hak Jang, Daejeon (KR); Nam Young Yoon, Daejeon (KR)

(73) Assignee: LG Chem, Ltd., Seoul (KR)

(21) Appl. No.: 15/774,781

(22) PCT Filed: Mar. 24, 2017
(86) PCT No.: PCT/KR2017/003159

§ 371 Date: May 9, 2018

(30) Foreign Application Priority Data
Mar. 31, 2016 (KR) 10-2016-0038799

(51) Int. Cl. F26B 3/04; F26B 21/10; F26B 21/14

(52) U.S. Cl. CPC F26B 3/04; F26B 21/14; F26B 21/10

(57) ABSTRACT

The present invention relates to a dryer and a controlling method thereof, and according to one aspect of the present invention, there is provided a dryer comprising a belt conveyor for conveying a first material to be dried, a heating device for generating a high temperature gas to dry the first material, a first supply part provided to supply the high temperature gas heated in the heating device toward the belt of the belt conveyor and a second supply part provided to supply the high temperature gas heated in the heating device to the ceiling side of the space in which the belt conveyor is located.

### TECHNICAL FIELD

The present invention relates to a dryer and a controlling method thereof.

The present application claims the benefit of priority based on Korean Patent Application No. 10-2016-0038799 filed on Mar. 31, 2016, the disclosure which is incorporated herein by reference in its entirety.

### BACKGROUND ART

FIG. 1 is a conceptual diagram showing a conventional dryer (1). The dryer (1) comprises a belt conveyor (10) for conveying a material to be dried, where the material to be dried is placed on the belt (11) and conveyed along the moving direction (MD) of the belt. At this time, the conventional dryer (1) is provided to supply a high temperature gas (hot gas, HG) used in the drying process to the belt conveyor (10) side. In addition, the dryer (1) may be used in a drying process of aprons.

On the other hand, in the case of drying the material, to which water, solvents (S) or volatile substances are added, in the apron dryer (1), water or solvents (S) condense on the dryer ceiling (C), when the temperature of the dryer ceiling (C) surface is lower than the dew point of a fluid in the dryer. At this time, when the water or solvents (S) condensed in the ceiling (C) collect and fall down to the moving belt (11), the quality of the product to be dried is adversely affected.

### DISCLOSURE

### Technical Problem

It is an object to be solved by the present invention to provide a dryer capable of preventing water or solvents from condensing on a ceiling of a dryer, and a controlling method thereof.

It is another object to be solved by the present invention to provide a dryer capable of supplying a high temperature gas into a dryer inside and a dryer ceiling side, respectively, through a single heating device, and a controlling method thereof.

### Technical Solution

To solve the above objects, according to one aspect of the present invention, there is provided a dryer comprising a belt conveyor for conveying a first material to be dried, a heating device for generating a high temperature gas to dry the first material, a first supply part provided to supply the high temperature gas heated in the heating device toward the belt of the belt conveyor and a second supply part provided to supply the high temperature gas heated in the heating device to the ceiling side of the space in which the belt conveyor is located.

According to another aspect of the present invention, there is provided a dryer comprising a belt conveyor for conveying a first material to be dried, a heating device for generating a high temperature gas to dry the first material, a first supply part provided to supply the high temperature gas heated in the heating device toward the belt of the belt conveyor, a second supply part provided to supply the high temperature gas heated in the heating device to the ceiling side of the space in which the belt conveyor is located, a first circulation part for recovering air between the belt conveyer and the ceiling and circulating it to the heating device and a second circulation part for recovering the gas passing through the ceiling side and circulating it to the heating device.

In addition, according to another aspect of the present invention, there is provided a method of controlling the dryer, comprising a step of supplying the high temperature gas generated in the heating device to the belt conveyor side and the ceiling side through first and second supply parts, respectively.

### Advantageous Effects

As described above, the dryer according to one embodiment and the controlling method thereof have the following effects.

The high temperature gas can be supplied to the inside and the ceiling side of the dryer, respectively, through a single heating device. In addition, by raising the temperature of the dryer ceiling side, it is possible to prevent water or solvents from condensing on the ceiling of the dryer.

### BRIEF DESCRIPTION OF DRAWINGS

FIG. 1 is a conceptual diagram showing a conventional dryer.

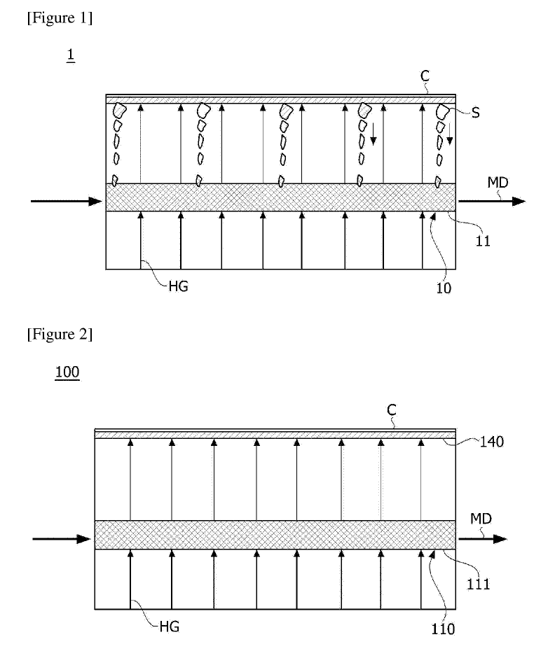

FIGS. 2 and 3 are conceptual diagrams illustrating dryers related to one embodiment of the present invention.

### MODE FOR INVENTION

Hereinafter, a dryer according to one embodiment of the present invention and a controlling method thereof will be described in detail with reference to the accompanying drawings.

In addition, the same or corresponding reference numerals are given to the same or corresponding components regardless of the reference numerals, and redundant explanations thereof will be omitted, and for convenience of explanation, the size and shape of each constituent member shown can be exaggerated or reduced.

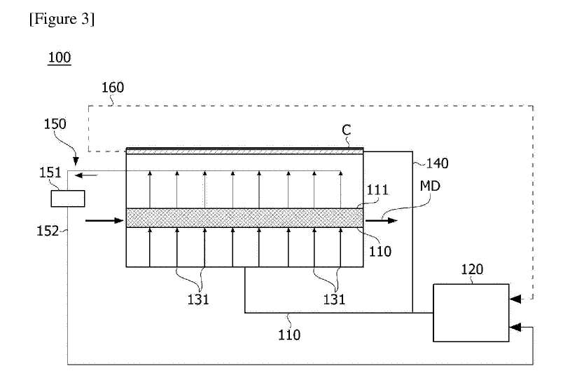

FIGS. 2 and 3 are conceptual diagrams illustrating dryers (100) related to one embodiment of the present invention.

The dryer (100) comprises a belt conveyor (110), a heating device (120), a first supply part (130), and a second supply part (140).

Specifically, the dryer (100) comprises a belt conveyor (110) for conveying a first material to be dried and a heating device (120) for generating a high temperature gas (HG) to dry the first material. The term “high temperature” should be hereby understood to refer to a usual temperature range used in the art to achieve the intended purpose (for example, drying of a specific material, etc.). For example, for drying the specific material, it may mean a temperature higher than the corresponding material.

In addition, the dryer (100) comprises a first supply part (130) provided to supply the high temperature gas heated in the heating device (120) toward the belt (111) of the belt conveyor (110), and a second supply part (140) provided to supply the high temperature gas heated in the heating device (120) to the ceiling (C) side of the space where the belt conveyor (110) is located. Furthermore, the first supply part (130) and the second supply part (140) are connected to the heating device (120), and the high temperature gas generated in the heating device (120) is supplied to the first supply part (130) and the second supply part (140).

On the other hand, the belt (111) of the belt conveyor (110) is provided so as to allow air to pass through. That is, when the high temperature gas (HG) is supplied to the belt (111) side, the high temperature gas (HG) dries the first material transferred on the belt (111) during the process of passing through the belt (111). For example, when the first material is seated on the upper surface of the belt (111), the high temperature gas (HG) may be supplied from the lower surface of the belt (111) to the upper surface side.

At this time, the first supply part (130) sprays the high temperature gas so that the high temperature gas (HG) passes through the belt (111) and moves toward the ceiling (C) side. On the other hand, the unexplained reference symbol MD indicates the moving direction (conveying direction) of the belt conveyor (110).

In addition, the first supply part (130) comprises a plurality of first supply lines (131) for supplying the high temperature gas (HG) to a plurality of points of the belt conveyor (110), respectively.

The second supply part (140) is provided to maintain the temperature of the ceiling (C) surface higher than the dew point of the second material so that a predetermined second material does not condense on the ceiling (C) surface in the drying process. In addition, the first material may be aprons, and the second material may be water or solvents. Specifically, when the temperature of the ceiling (C) surface is maintained to be higher than the condensation temperature of water or solvents, condensation of water or solvents occurring on the ceiling (C) surface can be prevented.

The heating device (120) may be driven by a single heat source and for example, may comprise a heat exchanger for heating the gas to be supplied to the first and second supply parts (130, 140) to a high temperature. Also, the heat exchanger may be provided to heat the gas using hot water, steam or hot oil (high temperature oil).

Alternatively, the heating device (120) may also be configured by a way of burning fuel or a way such as an electric heater.

Meanwhile, the heating device (120) may be provided to make the temperature of the gas supplied to the first supply part (130) different from the temperature of the gas supplied to the second supply part (140). For example, even when a single heat source (such as a heat exchanger) is used, the gases having different temperatures may be supplied to the first supply part (130) and the second supply part (140), respectively, by changing the heat exchange path (length, etc.). Specifically, the temperature of the gas supplied to the first supply part (130) may be set higher than the temperature of the gas supplied to the second supply part (140). In addition, the temperature of the ceiling (C) surface heated through the second supply part (140) can be controlled approximately similar to the temperature of the upper part of the belt (111).

Furthermore, the dryer (100) comprises a first circulation part (150) for recovering the air between the belt conveyor (110) and the ceiling (C) and circulating it to the heating device (120), and a second circulation part (160) for recovering the gas passing through the ceiling (C) side via the second supply part (140) and circulating it to the heating device (120).

Here, the second circulation part (160) may be connected to the second supply part (140), and for example, the second circulation part (160) and the second supply part (140) may be formed of a single pipe. There may be a structure that the single pipe connected to the heating device (120) is extended to the ceiling (C) side of the dryer (100) and then again connected from the ceiling (C) side to the heating device (120).

In addition, the first circulation part (130) may comprise a suction fan (151). Also, the first circulation part (130) may comprise a first circulation line (152) connecting the suction fan (151) and the heating device (120).

The controlling method of the dryer having the above structure is as follows.

A controlling method of the dryer related to one embodiment of the present invention comprises a step of supplying the high temperature gas generated in the heating device to the belt conveyor side and the ceiling side through the first and second supply parts, respectively. At this time, as described above, the temperatures of the gases supplied to the belt conveyor side and the ceiling side through the first and second supply parts, respectively, may be different from each other. In addition, the supply of the gas through the first and second supply parts may be performed simultaneously or sequentially. To this end, the first and second supply parts (130, 140) may be provided with flow control valves (not shown) for controlling the flow rate of the gas passing through the respective supply parts.

The preferred example of the present invention as described above is disclosed for exemplary purpose, where those skilled in the art having ordinary knowledge for the present invention can make various corrections, modifications and additions within idea and scope of the present invention, and such a correction, modification and addition should be considered as falling within the scope of the following claims.

### INDUSTRIAL APPLICABILITY

According to the present invention, by raising the temperature of the dryer ceiling side, it is possible to prevent water or solvents from condensing on the ceiling of the dryer.

1. A dryer comprising a belt conveyor for conveying a first material to be dried;
a heating device for generating a high temperature gas to dry said first material;
a first supply part provided to supply the high temperature gas heated in said heating device toward the belt of the belt conveyor; and
a second supply part provided to supply the high temperature gas heated in the heating device to the ceiling side of the space in which the belt conveyor is located.

2. The dryer according to claim 1,
wherein the belt of said belt conveyor is provided to allow air to pass through, and
said first supply part sprays the high temperature gas so that the high temperature gas passes through the belt and moves toward the ceiling side.

3. The dryer according to claim 2,
wherein said first supply part comprises a plurality of first supply lines for supplying the high temperature gas to a plurality of points of the belt conveyor, respectively.

4. The dryer according to claim 1,
wherein said second supply part is provided to maintain the temperature of said ceiling surface higher than the dew point of said second material so that a predetermined second material does not condense on the ceiling surface in the drying process.

5. The dryer according to claim 4,
wherein said second material is solvents or water.

6. The dryer according to claim 1,
wherein said first material is aprons.

7. The dryer according to claim 1,
wherein said heating device comprises a heat exchanger for heating the gas to be supplied to the first and second supply parts to a high temperature.

8. The dryer according to claim 7,
wherein said heat exchanger is provided to heat said gas using hot water, steam, or hot oil.

9. A dryer comprising a belt conveyor for conveying a first material to be dried;
a heating device for generating a high temperature gas to dry said first material;
a first supply part provided to supply the high temperature gas heated in said heating device toward the belt of the belt conveyor;
a second supply part provided to supply the high temperature gas heated in the heating device to the ceiling side of the space in which the belt conveyor is located;
a first circulation part for recovering air between said belt conveyer and said ceiling and circulating it to the heating device; and
a second circulation part for recovering the gas passing through said ceiling side and circulating it to the heating device.

10. The dryer according to claim 9,
wherein the second circulation part is connected to the second supply part.

11. The dryer according to claim 9,
wherein the belt of said belt conveyor is provided to allow air to pass through, and
said first supply part sprays the high temperature gas so that the high temperature gas passes through the belt and moves toward the ceiling side.

12. The dryer according to claim 11,
wherein said first supply part comprises a plurality of first supply lines for supplying the high temperature gas to a plurality of points of the belt conveyor, respectively.

13. The dryer according to claim 9,
wherein said second supply part is provided to maintain the temperature of said ceiling surface higher than the dew point of said second material so that a predetermined second material does not condense on the ceiling surface in the drying process.

14. The dryer according to claim 9,
wherein said first circulation part comprises a suction fan.

15. A method of controlling the dryer according to claim 1,
comprising a step of supplying the high temperature gas generated in the heating device to the belt conveyor side and the ceiling side through the first and second supply parts, respectively.

16. The method of controlling the dryer according to claim 15,
wherein the temperatures of the gases supplied to the belt conveyor side and the ceiling side through the first and second supply parts are different from each other.
